(19) United States
(12) Patent Application Publication
(10) Pub. No.: US 2026/0168866 A1
(43) Pub. Date: Jun. 18, 2026

(54) THERMOMETER ENCLOSURE, OBTURATOR, OBTURATOR-THERMOMETER ENCLOSURE ASSEMBLY, AND PRESSURE CELL

(71) Applicant: EWHA UNIVERSITY - INDUSTRY COLLABORATION FOUNDATION, Seoul (KR)

(72) Inventor: Won KANG, Seoul (KR)

(21) Appl. No.: 18/854,105

(22) PCT Filed: Jan. 22, 2024
(86) PCT No.: PCT/KR2024/001023

§ 371 Date: Oct. 4, 2024

(30) Foreign Application Priority Data
Apr. 7, 2023 (KR) 10-2023-0046380
Jul. 5, 2023 (KR) 10-2023-0087262
Jul. 5, 2023 (KR) 10-2023-0087264

(51) Int. Cl. G01K 13/20; G01K 1/08; G01K 7/18

(52) U.S. Cl. CPC G01K 13/20; G01K 1/08; G01K 7/18

(57) ABSTRACT

Disclosed are a thermometer enclosure, an obturator, an obturator-thermometer enclosure assembly, and a pressure cell. The disclosed obturator includes a base portion and a pressurizing portion that are formed integrally with each other, wherein the base portion and the pressurizing portion are disposed sequentially in a first direction, a length of the pressurizing portion in a second direction perpendicular to the first direction is smaller than the corresponding length of the base portion, and the base portion and the pressurizing portion have a central hole formed therein that passes through the base portion and the pressurizing portion in the first direction.

### TECHNICAL FIELD

Disclosed are a thermometer enclosure, an obturator, an obturator-thermometer enclosure assembly, and a pressure cell. More specifically, disclosed are a thermometer enclosure configured to isolate a thermometer from a pressure-transmitting medium within a pressure cell, an obturator, an obturator-thermometer enclosure assembly, and a pressure cell.

### BACKGROUND ART

High pressure is a useful technique in condensed matter physics. High pressure, in combination with low temperatures and strong magnetic fields, is frequently employed to investigate the physical properties of new materials.

Since virtually all temperature sensors are affected by pressure, accurately measuring the temperature of a pressurized sample within a pressure cell poses significant challenges. Typically, temperature is measured by attaching a thermometer to the external surface of the pressure cell or by drilling a hole in the body or a set screw of the pressure cell for sensor insertion. However, if the pressure dependence of the property to be measured is small or if precise temperature control is important, it is highly desirable to place the sensor as close to the sample as possible. One example is when studying physical properties in a temperature region very close to the transition temperature at which a first-order phase transition occurs.

Prior Art Document 1 demonstrated that commercially available small Pt thermometers, made by encapsulating a very thin Pt wire in an Al₂O₃ ceramic package, may be used interchangeably inside a pressure cell above 40 K. Using this setup, it was possible to accurately study the very weak pressure dependence of the superconducting transition temperature (T_{c}) of YBa₂Cu₃O₇ in the sample space of a cylindrical pressure cell with a length of 3 mm (see Prior Art Document 2). However, the sensitivity of the Pt thermometer sharply decreases as the temperature drops below approximately 40 K, making it unsuitable for use at cryogenic temperatures.

Recently, the most widely used thermometer in cryogenic environments is the Cernox® thermometer from Lake Shore Cryotronics, Inc., which uses the resistance of a zirconium oxynitride thin film as the sensor element and is available in various packages, including the bare chip (BR). In particular, due to its small size, it is easy to install the BR inside the pressure cell containing the sample under investigation. However, like most other thermometers, the resistance of Cernox also changes significantly with pressure. This makes it challenging to use the sensor element as a thermometer under pressure. For example, when a pressure of 20 kbar is applied to a Cernox® 1080 sensor at a cryogenic temperature of 5 K, the original resistance decreases by approximately 28%. If this is not compensated for, the apparent temperature could be off by an estimated range of 0.5 K to 1 K. Therefore, to use the thermometer under pressure, it must be isolated from the surrounding pressure. Otherwise, the thermometer would need to be calibrated at every temperature and pressure, which is practically impossible because the pressure value in most pressure cells varies with temperature.

### PRIOR ART DOCUMENTS

### Non-Patent Documents

(Non-Patent Document 1) 1. K. Murata, H. Yoshino, H. O. Yadav, Y. Honda, and N. Shirakawa, “Pt resistor thermometry and pressure calibration in a clamped pressure cell with the medium, daphne 7373.” Rev. Sci. Instrum. 68, 2490 (1997).
(Non-Patent Document 2) 2. K. Murata, Y. Honda, H. Oyanagi, and Y. Nishihara, “H. Ihara, n. terada, r. sugise, m. hirabayashi, m. tokumoto and y. kimura,” in Proceedings of the MRS International Meeting on Advanced Materials: Superconductivity, Vol. 6 (1989) p. 681.

### DISCLOSURE

### Technical Problem

An embodiment of the present disclosure provides a thermometer enclosure configured to isolate a thermometer from a pressure-transmitting medium within a pressure cell.

Another embodiment of the present disclosure provides an obturator comprising the thermometer enclosure.

Another embodiment of the present disclosure provides an obturator-thermometer enclosure assembly in which the thermometer enclosure is mounted in the obturator.

Another embodiment of the present disclosure provides a pressure cell including the obturator-thermometer enclosure assembly.

### Technical Solution

One aspect of the present disclosure provides a thermometer enclosure including:
a plug; and
a cap disposed to cover the plug,
wherein the plug includes a base portion and an insert portion that are formed integrally with each other,
wherein the base portion and the insert portion are disposed sequentially in a first direction,
wherein a length of the insert portion in a second direction perpendicular to the first direction is smaller than a corresponding length of the base portion, and
wherein the base portion and the insert portion each include a central hole formed therein, the central hole passing through the base portion and the insert portion in the first direction.

The base portion of the plug, the insert portion of the plug, and the cap may each have a hollow cylindrical shape.

The thermometer enclosure may be configured so that while the cap fully covers the plug, there exists an extra space between the insert portion of the plug and the cap.

The thermometer enclosure may further include a lead wire inserted into the plug via the central hole, wherein one end portion and the other end portion of the lead wire may be exposed to the outside of the central hole.

The thermometer enclosure may further include a temperature sensing element, wherein the temperature sensing element may be attached to the lead wire exposed toward the extra space formed between the insert portion of the plug and the cap.

The thermometer enclosure may further include an electrical feedthrough disposed in the central hole.

The cap may be configured so that, while the cap fully covers the plug, a surface of the cap opposing the base portion of the plug is flat, and the plug may be configured so that a surface of the base portion opposing the cap is tapered, such that a gap between the cap and the base portion gradually widens from the center to an end along the second direction.

Another aspect of the present disclosure provides an obturator including
a base portion and a pressurizing portion that are formed integrally with each other,
wherein the base portion and the pressurizing portion are disposed sequentially in a first direction,
wherein a length of the pressurizing portion in a second direction perpendicular to the first direction is smaller than a corresponding length of the base portion,
wherein a tip portion of the pressurizing portion includes a groove configured to accommodate the thermometer enclosure, and
wherein the base portion and the pressurizing portion include a central hole formed therein, the central hole passing through the base portion and the pressurizing portion in the first direction.

A diameter of the groove may be larger than a diameter of the thermometer enclosure, and the central hole may be in communication with the groove.

The base portion and the pressurizing portion may each have a hollow cylindrical shape.

The obturator may further include a sealing capsule fixing portion formed on the outer surface of a tip portion of the pressurizing portion.

Another aspect of the present disclosure provides an obturator-thermometer enclosure assembly including:
the obturator; and
a thermometer enclosure accommodated in the groove formed on a tip portion of the pressurizing portion of the obturator.

The lead wire included in the thermometer enclosure may extend out of the central hole through a gap between the thermometer enclosure and an inner wall of the pressurizing portion defining the groove, and the central hole formed in the obturator.

The obturator-thermometer enclosure assembly may further include an electrical feedthrough disposed in the central hole and a gap between the inner wall of the pressurizing portion defining the groove and the thermometer enclosure.

The above obturator-thermometer enclosure assembly may further include an attachment attached to a lead wire exposed to the outside of the pressurizing portion of the thermometer enclosure.

The attachment may include a sample, a temperature sensor, a pressure sensor, or a combination thereof.

Another aspect of the present disclosure provides a pressure cell including
the obturator-thermometer enclosure assembly.

The pressure cell may include:
an outer body in a hollow cylindrical shape;
an inner body which is in a hollow cylindrical shape and configured to be insertable into a hollow of the outer body;
the obturator-thermometer enclosure assembly configured to be insertable into a hollow of the inner body; and
a clamping nut configured to be threadedly engaged with the outer body to positionally secure the obturator.

The outer body and the inner body may be pre-stressed.

The inner wall of the outer body may be tapered in a length direction, and the outer wall of the inner body may be tapered in a length direction.

An outer diameter of the inner body may be configured to be larger than a corresponding inner diameter of the outer body.

The pressure cell may be configured so that an extra space exists between the pressurizing portion and the inner body while the obturator-thermometer enclosure assembly is fully inserted in the hollow of the inner body.

The pressure cell may further include a pressure transmitting medium filled in the extra space between the pressurizing portion and the inner body.

The pressure cell may further include a hollow sealing capsule having an opening, wherein the sealing capsule may be configured so that the entire outer surface of the sealing capsule is in close contact with the inner wall of the inner body, and the inner surface of the sealing capsule around the opening is in close contact with the sealing capsule fixing portion of the obturator.

### Advantageous Effects

A thermometer enclosure according to an embodiment of the present disclosure is configured to isolate a thermometer from a pressure-transmitting medium inside a pressure cell, allowing the temperature of the sample to be measured under ambient pressure, regardless of pressure fluctuations within the pressure cell.

An obturator according to an embodiment of the present disclosure can perform not only its inherent function as an obturator but also serve as a sample holder, electrical feedthrough, and piston.

In addition, the pressure cell according to an embodiment of the present disclosure can be successfully used in both superconducting and electromagnet environments, and due to having a minimized number of components, significantly reduces the risk of pressure-transmitting medium leakage, allows for 360-degree rotation even in a small sample space. Further, since the pressure can be adjusted without opening the pressure cell, the same sample can be studied at various pressure levels, thereby enhancing the reliability of the research results.

### DESCRIPTION OF DRAWINGS

FIG. 1 is a schematic diagram illustrating a thermometer enclosure according to an embodiment of the present disclosure.

FIG. 2 is a plan view photograph of a plug of a thermometer enclosure actually fabricated according to an embodiment of the present disclosure.

FIG. 3 shows a set of photographs of constitutive components of a thermometer enclosure actually fabricated according to an embodiment of the present disclosure.

FIG. 4 is a schematic diagram illustrating an obturator-thermometer enclosure assembly according to an embodiment of the present disclosure.

FIG. 5 is a photograph showing an upper portion of an obturator-thermometer enclosure actually fabricated according to an embodiment of the present disclosure.

FIG. 6 is a schematic diagram illustrating a pressure cell according to an embodiment of the present disclosure.

FIG. 7 is a graph showing the resistance of an encapsulated Cernox® thermometer at three different temperatures when a pressure cell actually manufactured according to an embodiment of the present disclosure was pressurized at three different pressure values.

FIG. 8 is a graph showing repeated measurement values of resistance of a Pt thermometer as a function of temperature read from an encapsulated Cernox® thermometer when a pressure cell actually manufactured according to an embodiment of the present disclosure was pressurized to 14 kbar.

FIG. 9a and FIG. 9b are graphs showing resistance changes of (TMTSF)₂FSO₃ according to temperatures measured by a Cernox® thermometer inside a pressure cell actually manufactured according to an embodiment of the present disclosure, and a thermometer attached to an outer wall of the pressure cell, respectively.

### MODE FOR INVENTION

Hereinafter, a thermometer enclosure, an obturator, an obturator-thermometer enclosure assembly, and a pressure cell according to an embodiment of the present disclosure will be described in detail with reference to the drawings.

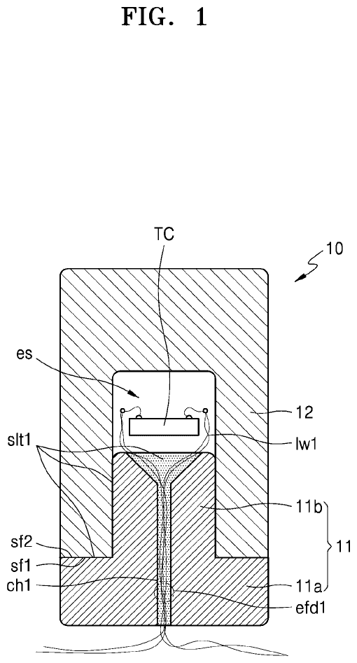

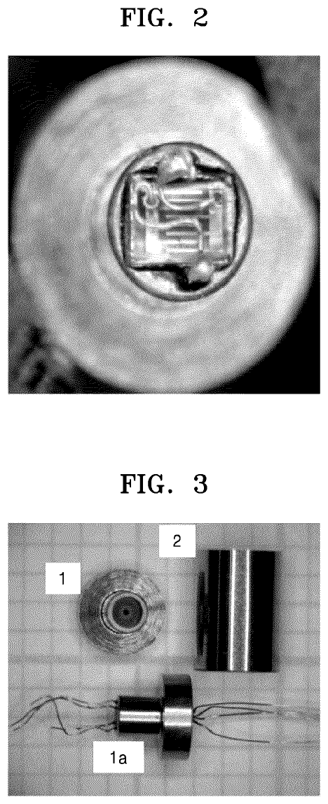

FIG. 1 is a schematic diagram illustrating a thermometer enclosure 10 according to an embodiment of the present disclosure, FIG. 2 is a plan view photograph of a plug of a thermometer enclosure actually fabricated according to an embodiment of the present disclosure, and FIG. 3 is a set of photographs showing constituent components of a thermometer enclosure actually fabricated according to an embodiment of the present disclosure. FIG. 3 (1) is a plan view photograph of the plug, FIG. 3 (1a) is the plug with a lead wire lw1 embedded therein, and FIG. 3 (2) is a side view photograph of the cap.

Referring to FIG. 1, a thermometer enclosure 10 according to an embodiment of the present disclosure includes a plug 11 and a cap 12.

The plug 11 may include a base portion 11a and an insert portion 11b.

The base portion 11a and the insert portion 11b may be formed integrally with each other.

In addition, the base portion 11a and the insert portion 11b may be disposed sequentially along a first direction (i.e., the vertical direction in FIG. 1).

A length of the insert portion 11b in a second direction (i.e., the horizontal direction in FIG. 1) perpendicular to the first direction may be smaller than the corresponding length of the base portion 11a.

In addition, the base portion 11a and the insert portion 11b may have a central hole ch1 formed therein that passes through the base portion 11a and the insert portion 11b in the first direction.

In addition, the base portion 11a of the plug 11, the insert portion 11b of the plug 11, and the cap 12 may each have a hollow cylindrical shape (see FIG. 1 and FIG. 3).

In addition, the thermometer enclosure 10 may be configured so that there exists an extra space es (i.e., thermometer space) between the insert portion 11b of the plug 11 and the cap 12 while the cap 12 fully covers the plug 11.

In addition, the thermometer enclosure 10 (in particular, the plug 11) may further include a lead wire lw1 (see FIGS. 1 to 3).

The lead wire lw1 may be inserted into the plug 11 via a central hole ch1 wherein one end portion and the other end portion of the lead wire lw1 may each be exposed to the outside of the central hole 1 (see FIGS. 1 to 3).

In addition, the lead wire lw1 may include four lead wires for four-terminal resistance measurement.

In addition, the lead wire lw1 may include a gold lead wire, a copper lead wire, an insulated gold lead wire, an insulated copper lead wire, or a combination thereof.

In addition, the lead wire lw1 may include a plurality of lead wires each having a diameter of 0.05 mm to 0.14 mm.

In addition, the thermometer enclosure 10 (in particular, the plug 11) may further include an electrical feedthrough efd1.

The electrical feedthrough efd1 may be disposed in the central hole ch1. The electrical feedthrough efd1 may be formed by completely sealing the gaps in the central hole ch1 in which the lead wire lw1 is disposed, with an epoxy resin, thereby enabling the electrical feedthrough efd1 to simultaneously function as a conducting wire and a pressure barrier material. For example, the epoxy resin may include Stycast® 2850 FT. Specifically, the lead wire lw1 may be inserted into the central hole ch1 of the plug 11, and the central hole ch1 may be sealed with an epoxy resin, taking care to ensure that no air bubbles are trapped in the epoxy resin. In addition, prior to sealing the central hole ch1 of the plug 11 with an epoxy resin, the inner wall of the plug 11 defining the central hole ch1 and the lead wire lw1 may be cleaned with a cleaning solution (for example, methyl alcohol).

In addition, the thermometer enclosure 10 may further include a sealant slt1 that is filled in a tip portion of the plug 11 and a gap between the plug 11 and the cap 12 while the cap 12 fully covers the plug 11. Here, the tip portion of the plug 11 refers to the end portion of the plug 11 on the side of the insert portion 11b, that is opposite to the end portion of the plug 11 on the side of the base portion 11a.

In addition, the thermometer enclosure 10 may further include a temperature sensing element TC.

The temperature sensing element TC may be attached to the lead wire lw1 exposed toward an extra space es formed between the insert portion 11b of the plug 11 and the cap 12.

In addition, while the cap 12 fully covers the plug 11, the cap 12 may be configured so that a surface sf2 opposing the base portion 11a of the plug 11 is flat, and the plug 11 may be configured so that a surface sf1 of the base portion 11a opposing the cap 12 is tapered. Consequently, the gap between the cap 12 and the base portion 11a may gradually increase from the center towards an end along the second direction (i.e., the horizontal direction in FIG. 1). Accordingly, the thickness of the sealant slt1 filled in the gap between the cap 12 and the base portion 11a may increase from the center towards an end, thereby maximizing the effect of sealing the gap.

The thermometer enclosure 10 may be manufactured from tungsten carbide WC. In particular, given that WC has a high ultimate compressive strength of approximately 2.7 GPa and a large Poisson's ratio of 0.31, it is widely used in applications requiring high compressive strength. For example, WC may be used as a material for pistons employed in high-pressure experiments. For the thermometer enclosure 10, which is exposed to high compressive stress due to the internal pressure of the pressure cell containing it, WC is a suitable choice of material.

The thermometer enclosure 10 according to an embodiment of the present disclosure with the above configuration is essentially a small pressure cell without a pressure-transmitting medium that inherently has a detrimental effect. The thermometer enclosure 10 may maintain the surroundings of the temperature sensing element TC at ambient pressure while the external pressure (i.e., the pressure inside the pressure cell) significantly increases. Therefore, the temperature sensing element TC mounted inside the thermometer enclosure 10 may always operate under atmospheric pressure without being affected by the external pressure, that is, the pressure inside the pressure cell.

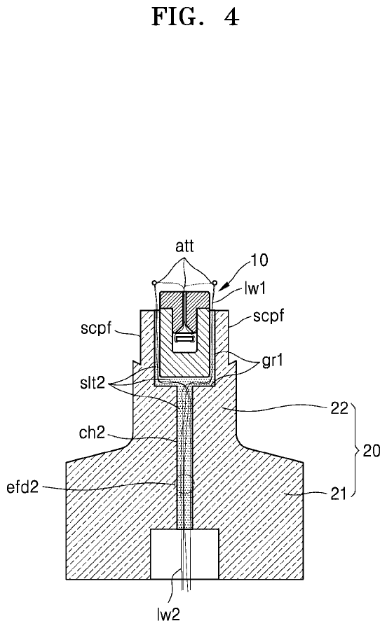

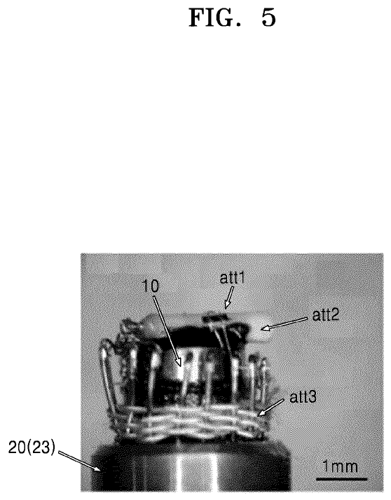

FIG. 4 schematically illustrates an obturator 20-thermometer enclosure 10 assembly according to an embodiment of the present disclosure, and FIG. 5 is a photograph showing an upper part of an obturator-thermometer enclosure actually fabricated according to an embodiment of the present disclosure. In FIG. 5, “att1” denotes a sample, “att2” denotes an auxiliary temperature sensor (ceramic package Pt sensor) inserted for comparison, and “att3” denotes a manganin pressure sensor.

Referring to FIG. 4, an obturator 20 according to an embodiment of the present disclosure may include a base portion 21 and a pressurizing portion 22.

The base portion 21 and the pressurizing portion 22 may be formed integrally with each other.

In addition, the base portion 21 and the pressurizing portion 22 may be disposed sequentially in a first direction (i.e., the vertical direction in FIG. 4).

A length of the pressurizing portion 22 in a second direction (i.e., the horizontal direction in FIG. 4) perpendicular to the first direction may be smaller than the corresponding length of the base portion 21.

A tip portion of the pressurizing portion 22 may have a groove gr1 formed therein that is configured to accommodate the thermometer enclosure 10. Here, the tip portion of the pressurizing portion 22 refers to the end portion of the pressurizing portion 22 that is opposite to the end portion on the side of the base portion 21.

A diameter of the groove gr1 may be larger than a diameter of the thermometer enclosure 10. In addition, if the thermometer enclosure 10 is inserted into the center of the groove gr1, a gap may be formed between the outer surface of the thermometer enclosure 10 and the inner wall of the pressurizing portion 22 defining the groove gr1.

In addition, the base portion 21 and the pressurizing portion 22 may have a central hole ch2 formed therein that passes through the base portion 21 and the pressurizing portion 22 in the first direction.

The central hole ch2 may be in communication with the groove gr1.

In addition, the base portion 21 and the pressurizing portion 22 may each have a hollow cylindrical shape.

In addition, the obturator 20 may further include a sealing capsule fixing portion scpf.

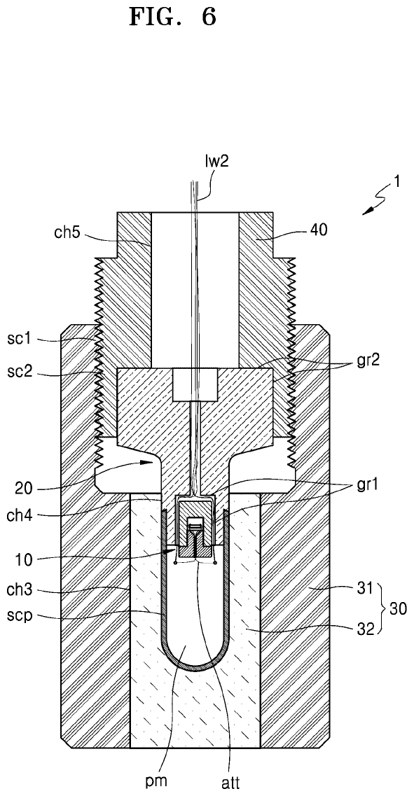

The sealing capsule fixing portion scpf may be formed on an outer surface of a tip portion of the pressurizing portion 22. In particular, the sealing capsule fixing portion scpf may be formed at the tip portion of the pressurizing portion 22, wherein the outer diameter of the sealing capsule fixing portion scpf may be configured to be smaller than the outer diameter of the remaining pressurizing portion 22 that does not correspond to the sealing capsule fixing portion scpf. In addition, a portion of the outer surface of the sealing capsule fixing portion scpf may be configured to be covered by the outer surface of the remaining pressurizing portion 22 that does not correspond to the sealing capsule fixing portion scpf, thereby creating a groove (one end portion of a sealing capsule scp described below may be inserted into this groove). In this regard, referring to FIG. 6 with FIG. 4, it can be seen that an upper portion of the sealing capsule scp is inserted into the outer surface of a lower portion of the remaining pressurizing portion 22 that does not correspond to the sealing capsule fixing portion scpf.

In addition, the obturator 20 may further include a lead wire lw2.

The lead wire lw2 may be inserted into the obturator 20 via the central hole ch2, while at least one of one end portion and the other end portion of the lead wire lw2 may be exposed to the outside of the central hole ch2.

In addition, the lead wire lw2 may be connected to the lead wire lw1 by a method such as welding.

In addition, the lead wire lw2 may contain 8 to 16 lead wires.

In addition, the lead wire lw2 may include a gold lead wire, a copper lead wire, an insulated gold lead wire, an insulated copper lead wire, or a combination thereof.

The obturator 20 may be made of a metal.

The metal may include a BeCu alloy, but the present disclosure is not limited thereto.

In addition, the obturator 20 may be reused multiple times in most cases.

In addition, the lead wire lw2 may include a plurality of lead wires each having a diameter of 0.05 mm to 0.14 mm.

Referring to FIG. 4, an obturator 20-thermometer enclosure 10 assembly according to an embodiment of the present disclosure will be described in detail.

The obturator 20-thermometer enclosure 10 assembly may include the obturator 20 and the thermometer enclosure 10.

The thermometer enclosure 10 may be accommodated in the groove gr1 formed at the tip portion of the pressurizing portion 22 of the obturator 20.

The lead wire lw1 included in the thermometer enclosure 10 may be connected to the lead wire lw2 of the obturator 20 by a method such as welding.

In addition, the obturator 20-thermometer enclosure 10 assembly may further include an electrical feedthrough efd2.

The electrical feedthrough efd2 may be disposed in the central hole ch2 and the gap between the thermometer enclosure 10 and the inner wall of the pressurizing portion 22 defining the groove gr1. The electrical feedthrough efd2 is formed by completely sealing, with an epoxy resin, the gap between the thermometer enclosure 10 and the inner wall of the pressurizing portion 22 defining the groove gr1, as well as the gap in the central hole ch2 (the lead wire lw2 is disposed in these gaps) and thus may simultaneously act as a conducting wire and a pressure barrier material. For example, the epoxy resin may include Stycast® 2850 FT. Specifically, the lead wire lw2 may be inserted into the central hole ch2 of the obturator 20, and the central hole ch2 may be sealed with an epoxy resin, taking care to ensure that no air bubbles are trapped in the epoxy resin. In addition, prior to sealing the central hole ch2 of the obturator 20 with an epoxy resin, the inner wall of the obturator 20 defining the central hole ch2 and the lead wire lw2 may be cleaned with a cleaning solution (for example, methyl alcohol).

If using Stycast® 2850 FT as the epoxy resin, the thermometer enclosure 10 may be permanently affixed to the obturator 20. Alternatively, if using removable adhesives such as 5-minute epoxy and GE7031 varnish instead of Stycast® 2850 FT as the epoxy resin, it is possible to recover and reuse the thermometer enclosure 10.

In addition, the obturator 20-thermometer enclosure 10 assembly may further include an attachment att.

The attachment att may be attached to the lead wire lw2 exposed to the outside from the side of the pressurizing portion 22 through the central hole ch2.

In particular, the attachment att may include a sample, a temperature sensor, a pressure sensor, or a combination thereof.

The sample may be introduced into the obturator 20-thermometer enclosure 10 assembly for the purpose of measuring its physical quantities (such as temperature, pressure, resistance, etc.).

The obturator 20-thermometer enclosure 10 assembly according to an embodiment of the present disclosure, which has the configuration as described above, simultaneously functions as a sealing member, sample holder, electrical feedthrough, and piston, thereby eliminating the need for a slightly magnetic tungsten carbide piston, which is an essential component of conventional pressure cells.

Hereinbelow, referring to FIG. 6, a pressure cell 1 according to an embodiment of the present disclosure will be described in detail.

Referring to FIG. 6, the pressure cell 1 according to an embodiment of the present disclosure includes an obturator 20-thermometer enclosure 10 assembly described above.

Specifically, the pressure cell 1 may include an outer body 31, an inner body 32, the obturator 20-thermometer enclosure 10 assembly, and a clamping nut 40.

The outer body 31 and the inner body 32 may each have a hollow cylindrical shape.

The inner body 32 may be configured to be insertable into a hollow (i.e., central hole ch3) of the outer body 31.

The obturator 20-thermometer enclosure 10 assembly (in particular, the obturator 20) may be configured to be insertable into a hollow of the inner body 32 (i.e., a central hole ch4).

The outer body 31 and the inner body 32 may be pre-stressed. Even if the internal pressure of the inner body 32 increases, this allows the outer body 31 and the inner body 32 to withstand the increased internal pressure effectively.

The double-walled structure of the main body 30, composed of the outer body 31 and the inner body 32, was preferred by the present inventors over more sophisticated autofrettage, as it can be easily manufactured even by non-experts. Specifically, both ends of the outer body 31 and the inner body 32 were flattened, and a hollow (i.e., central holes ch3 and ch4) was drilled in the outer body 31 and the inner body 32, respectively. The end of the hollow (i.e., central hole ch4) formed in the inner body 32 may be formed into a hemispherical shape to efficiently distribute deformation.

In addition, the outer body 31 may be formed such that the inner wall of the outer body 31 is tapered along a length direction (i.e., the first direction) (Feature 1). Specifically, the outer body 31 may be formed such that the diameter of a hollow (i.e., central hole ch3) formed therein continuously decreases at a constant rate along a length direction (i.e., the first direction).

In addition, the inner body 32 may be formed such that the outer wall thereof is tapered in a length direction (i.e., the first direction) (Feature 2). Specifically, the inner body 32 may be formed such that the outer diameter thereof continuously decreases at a constant rate along a length direction (i.e., the first direction).

In addition, the inner body 32 may be configured so that the outer diameter thereof is larger than the corresponding inner diameter of the outer body 31 (Feature 3). For example, the inner body 32 may be configured so that the outer diameter thereof is approximately 1.5% larger than the corresponding inner diameter of the outer body 31. Here, “the outer diameter of the inner body 32” refers to the outer diameter of the inner body 32 measured before the inner body 32 is inserted into the outer body 31, and “the corresponding inner diameter of the outer body 31” refers to the inner diameter of the outer body 31 measured before the inner body 32 is inserted into the outer body 31. In addition, “the corresponding inner diameter of the outer body 31” refers to the corresponding inner diameter of the outer body 31 at the position corresponding to the outer diameter of the inner body 32 when the inner body 32 is fully inserted into the outer body 31.

Due to Features 1 to 3, the inner body 32 may be forcibly inserted into a tapered hollow (i.e., central hole ch3) of the outer body 31 with a force more than three times greater than the maximum force of operation. Here, “maximum force of operation” refers to the maximum attainable pressure of extra space (i.e., sample space), which will be described later, surrounded by the inner wall of the inner body 32 and the outer wall of the pressurizing portion 22 of the obturator 20.

The clamping nut 40 may be configured to be threadedly engaged with the outer body 31 to positionally secure the obturator 20. Specifically, female threads sc1 formed on the inner wall of an upper portion of the outer body 31 and male threads sc2 formed on the outer wall of a lower portion of the clamping nut 40 may be threadedly engaged with each other.

In addition, a hollow (i.e., central hole ch5) may be formed in the clamping nut 40, allowing the lead wire lw2 to be drawn out of the pressure cell 1 through the hollow.

In addition, the clamping nut 40 may include a groove gr2 formed therein, and the entire upper end portion and part of the side end portion of the base portion 21 of the obturator 20 may come in close contact with this groove gr2, thereby allowing the clamping force (i.e., position fixing force) of the clamping nut 40 to be directly transferred to the obturator 20.

Meanwhile, if the size of the pressure cell 1 is small (for example, when the diameter of the pressure cell 1 is 8 mm or less), the pressure cell 1 may include a jig (not shown) configured to secure the position of the obturator 20 from the outside instead of using the clamping nut 40.

In addition, the pressure cell 1 may be configured so that there exists an extra space (i.e., sample space) between the pressurizing portion 22 and the inner body 32 while the obturator 20 is fully inserted into the hollow (i.e., central hole ch4) of the inner body 32.

The outer body 31, the inner body 32, the obturator 20, and the clamping nut 40 may be made of a metal.

The metal may include a BeCu alloy, but the present disclosure is not limited thereto.

In addition, the pressure cell 1 may further include a pressure-transmitting medium pm. This pressure-transmitting medium pm may be filled in the extra space formed between the pressurizing portion 22 and the inner body 32 while the obturator 20 is inserted into a hollow (i.e., central hole ch4) of the inner body 32.

The pressure-transmitting medium pm may include silicone oil, FC-77 Fluorinert (3M), Daphne 7373 oil (Idemitsu), or a combination thereof. In particular, Daphne 7373 oil may be a good choice for studying fragile organic conductors. In addition, the solidification of Daphne oil may be easily detected by either a small change in the slope of the resistance versus temperature curve, resulting from the difference in thermal contraction coefficients between the liquid and solid states, or by a change in the magnitude of the temperature gradient in thermopower measurements, arising from the difference in thermal dissipation towards the liquid or solidified medium.

In addition, the pressure cell 1 may further include a sealing capsule scp.

The sealing capsule scp may be hollow and have an opening.

In addition, the sealing capsule scp may be configured so that the entire outer surface of the sealing capsule scp is in close contact with the inner wall of the inner body, and an inner surface of the sealing capsule scp around the opening is in close contact with the sealing capsule fixing portion scpf of the obturator 20.

This type of sealing, implemented by disposing the sealing capsule scp in close contact with the inner wall of the inner body 32 and the sealing capsule fixing portion scpf of the obturator 20, has a very simple structure but is surprisingly stable against the leakage of the pressure-transmitting medium pm, offering the advantage of allowing multiple pressure adjustments during a single assembly use. After the experiment is completed, the pressure cell 1 may be reused multiple times by adding a small amount of the pressure-transmitting medium pm while leaving the sealing capsule scp in the pressure cell 1.

The sealing capsule scp may be made of polytetrafluoroethylene (i.e., Teflon).

In addition, the pressure cell 1 may further include a device (not shown) that is capable of extracting the obturator 20-thermometer enclosure 10 assembly from the inner body 32 after pressure release.

The pressure cell 1 according to an embodiment of the present disclosure, having the configuration described above, has a simple structure, is suitable for material research in strong magnetic fields, and due to having a minimized number of components, significantly reduces the risk of pressure-transmitting medium pm leakage. Furthermore, the pressure cell 1 allows for modular design and easy size expansion, making it possible to manufacture a small cell suitable for angular-dependent studies under strong magnetic fields at low temperatures. Furthermore, pressure adjustments can be made without opening the pressure cell 1, enabling the same sample to be studied at various pressure levels, thereby enhancing the reliability of the results.

In addition, the enclosure 10 and the pressure cell 1 containing the same can isolate a temperature sensing element TC from a pressure-transmitting medium pm inside the pressure cell 1, allowing precise measurement and control of the sample's temperature regardless of pressure changes. In addition, the enclosure 10 and the pressure cell 1 containing the same may be useful for determining changes in physical properties due to small temperature variations or for accurately measuring the amount of hysteresis in first-order phase transitions. The enclosure 10 and the pressure cell 1 containing the same are also useful for precisely controlling the sample temperature as the sample approaches a transition temperature from one side.

Furthermore, the pressure cell 1 may maintain high pressure within a small volume where the sample under investigation is placed. The electrical feedthrough may be implemented through the hollow (i.e., central hole ch2) of the obturator 20 in the pressure cell 1 to achieve electrical connections to the sample therein.

In addition, the temperature sensing element TC mounted in the pressure cell 1 (in particular, the enclosure 10) has the potential to serve as a precise cryogenic temperature sensor in various extreme environments, including high magnetic fields and high pressures. This may be achieved by placing the temperature sensing element TC inside the pressure cell 1 (in particular, the enclosure 10) while ensuring it is isolated from the pressure-transmitting medium pm.

Hereinbelow, the present disclosure will be described through the following examples; however, the present disclosure is not limited to these examples.

### Example 1: Fabrication of Pressure Cell

A thermometer enclosure was manufactured from sintered non-magnetic tungsten carbide (WC). A hole with a diameter of 0.2 mm was drilled in the center of a plug. Four enameled 50 μm-diameter copper wires were inserted into the hole and then filled with Stycast® 2850 FT epoxy. A Cernox® thermometer was used as a temperature sensing element, and the lowest effective temperature of this thermometer is 0.1 K. The sensing element of the Cernox® thermometer was deposited on a thin rectangular sapphire substrate with an area of 0.965×0.762 mm². Specifically, because the BG package comes with two ball-bonded gold lead wires with a diameter of 50 μm, the BG package for the Cernox® thermometer was chosen over the BR. The Au lead wire was cut short and soldered to a 50 μm-diameter copper wire in a four-wire configuration inside the thermometer enclosure. The inner diameter of the thermometer enclosure was 1.5 mm, slightly larger than the diagonal length of the sapphire substrate on which the sensing element was deposited. The surfaces of the WC components that come into contact with each other were coated with Stycast® epoxy before assembly. In addition, a 2-degree taper was created on the flat surface of the plug to provide space for an additional thin layer of Stycast® epoxy to be filled around the neck of the plug. The outside diameter of the thermometer enclosure was 3 mm, which was easily sized to fit into the sample space of the pressure cell (diameter 5 mm). The overall length of the assembled thermometer enclosure was 5 mm.

After curing the Stycast® epoxy overnight, the thermometer enclosure was secured onto the obturator, which had a groove machined with a diameter of 3.5 mm and a depth of 4.5 mm to accommodate the thermometer enclosure. Four copper wires with a diameter of 50 μm emerging from the thermometer enclosure were soldered to a 0.13 mm copper wire of the obturator. In addition, a 0.05 mm manganin wire gauge and a ceramic package Pt thermometer (Netsusin MC0804) were added to enable pressure monitoring and temperature comparison, respectively, at room temperature.

Finally, a small crystal of the organic conductor (TMTSF)₂FSO₃ was mounted to measure interlayer resistance, allowing for the simultaneous execution of pilot experiments. The prepared obturator was inserted into a simplified double-walled piston-cylinder pressure cell made of a BeCu alloy. The sample space was filled with Daphne 7373 oil, which serves as a pressure-transmitting medium, and pressure was applied at room temperature using a hydraulic press. After sealing the pressure cell, the internal pressure was determined by measuring the change in manganin resistance at room temperature.

### Evaluation Example 1: Resistance Measurement of Cernox® Thermometer Inside Enclosure Depending on Pressure and Temperature

When the pressure cell manufactured in Example 1 was pressurized to three different pressure values, the resistance of the Cernox® thermometer was measured at three different temperatures, and the results were plotted as a graph in FIG. 7. Specifically, FIG. 7 shows the resistance of the Cernox® thermometer (CX-1050-BG-HT) protected by an enclosure, at three different temperatures (i.e., 5 K, 77.4 K, and 302 K) when the pressure cell was subjected to atmospheric pressure, 7.4 kbar, and 14.1 kbar. The thermometer enclosure inside the pressure cell was exposed to three different pressure values: vacuum, 7.4 kbar, and 14.1 kbar. All pressure values provided in the present specification were obtained from the increase in resistance of the built-in manganin pressure gauge. Daphne 7373 oil was used as the pressure medium, and the pressure drop at low temperatures was approximately 1.5 kbar, regardless of the initial pressure at room temperature.

As seen in FIG. 7, the curves converge into a single curve, indicating that the Cernox® thermometer, protected by the enclosure, is insensitive to the surrounding pressure. The inset in FIG. 7 shows the change in the resistance of the Cernox® thermometer relative to the average resistance of the Cernox® thermometer at three different pressures. At a given temperature, the change in resistance due to pressure variation is smaller than the temperature instability. These results can be compared to the BR Cernox® 1080 thermometer, where exposure to a pressure of 15 kbar caused a resistance decrease of approximately 10% at 75 K and 25% at 5 K. This is the only information available on the pressure effect on the Cernox® thermometer (see Reference 1). The reliability and stability of the Cernox® thermometer, protected by the enclosure, were tested by repeatedly performing multiple thermal cycles between room temperature and cryogenic temperatures under a constant pressure of 14.1 kbar.

Reference 1 above refers to E. Gati, G. Drachuck, L. Xiang, L.-L. Wang, SL Budko, and PC Caneld, “Use of cernox thermometers in ac specific heat measurements under pressure,” Review of Sci. Instrum. 90, 023911 (2019).

Evaluation Example 2: Repeated Measurement of Resistance of Pt Thermometer as Function of Temperature Readings from Cernox® Thermometer Protected by Enclosure

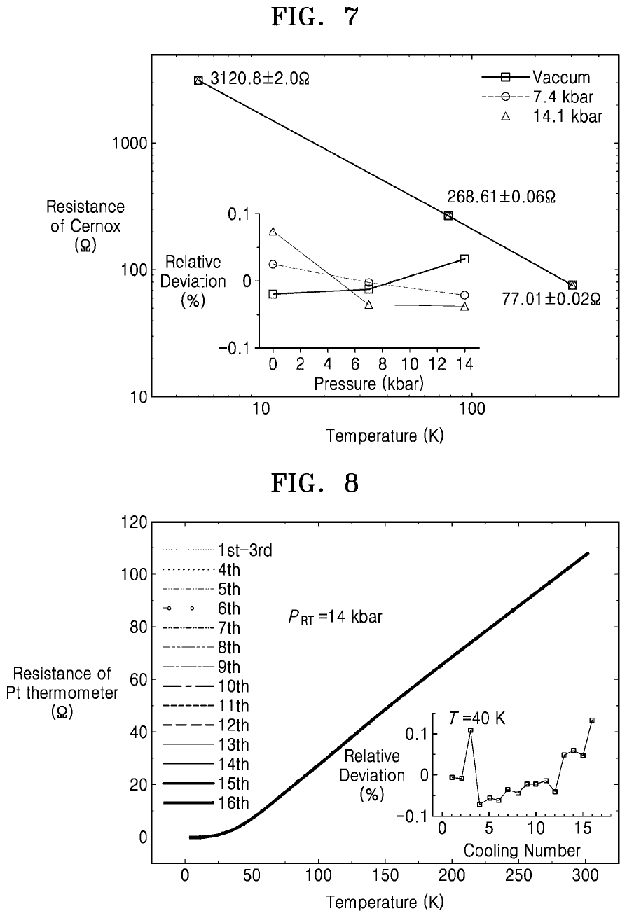

FIG. 8 shows the results of thermal cycle measurements, repeated 15 times on a Pt resistance thermometer. Cooling and heating were repeated at a rate of 1 K/min. During the experiment, the resistance of the Pt thermometer located in the sample space was monitored as a function of the temperature measured by a Cernox® thermometer protected by the enclosure. The measurements were repeated 15 times per day at one-day intervals. Over an extended period of time, no change in temperature corresponding to the resistance value of the Cernox® thermometer was observed. The inset in FIG. 8 shows the change in the resistance of the Pt thermometer relative to the average resistance of the Pt thermometer recorded at 40 K, the lowest temperature at which the Pt thermometer remains useful.

Since the Netsushin MC0803 Pt thermometer has already been proven to withstand pressures of up to 15 kbar (see Prior Art Document 1), the present inventors expected to observe a shift in the curve if the pressure had any impact on the encapsulated Cernox® thermometer. However, the present inventors did not observe any significant drift in the temperature readings obtained from the Cernox® thermometer protected by the enclosure, even after multiple thermal cycles over an extended period. The manganin pressure gauge indicated that the pressure consistently returned to the same value. In addition, this experiment also reconfirmed that the resistance of the ceramic package Pt thermometer is insensitive to pressure.

Evaluation Example 3: Measurement of Resistance Changes of (TMTSF)₂FSO₃ Depending on Temperature

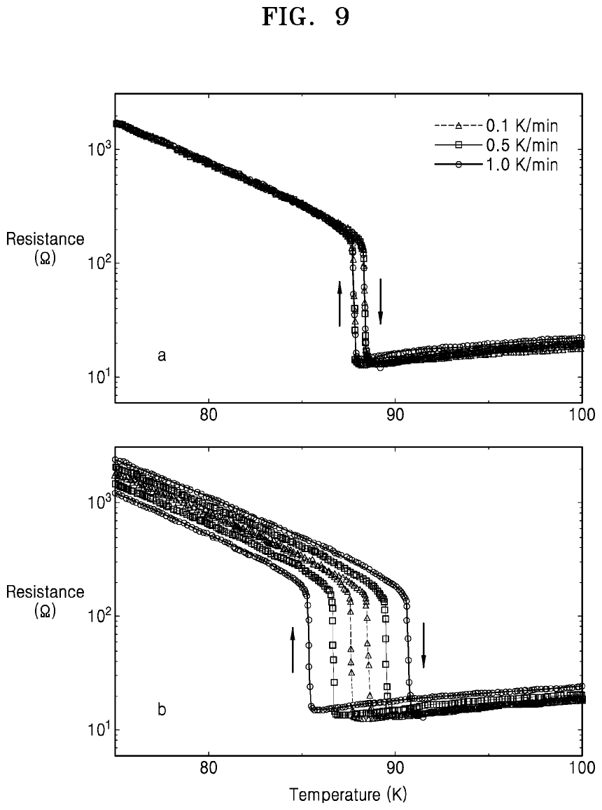

FIG. 9a shows the resistance versus temperature near the anion ordering transition temperature of (TMTSF)₂FSO₃, when the temperature was measured using the Cernox® thermometer protected by the enclosure and embedded in the sample space. FIG. 9b shows the resistance versus temperature near the anion ordering transition temperature of (TMTSF)₂FSO₃, when the temperature was measured using the SD package Cernox® thermometer attached to the external surface of the pressure cell. The amount of hysteresis may be accurately determined in FIG. 9a, regardless of the cooling and heating rates.

Specifically, the advantage of placing the thermometer as close as possible to the sample is illustrated in FIG. 9. The present inventors used the organic conductor (TMTSF)₂FSO₃, which undergoes various types of phase transitions depending on the exposed pressure. (TMTSF)₂FSO₃ undergoes a typical first-order phase transition due to anion ordering at ambient pressure. FIG. 9a and FIG. 9b show the resistance of (TMTSF)₂FSO₃ as a function of temperature measured by the Cernox® thermometer inside the pressure cell and the thermometer attached to the outer wall of the pressure cell, respectively. The applied cooling and heating rates varied from 0.1 K/min to 1.0 K/min. When the temperature was measured using the external thermometer, the amount of hysteresis increased as the cooling/heating rate increased, reflecting the delayed response of the sample temperature compared to the thermometer. In contrast, FIG. 9a shows that when the sample temperature was measured by the Cernox® thermometer protected by the enclosure embedded inside the pressure cell with the sample, the cooling and heating curves were independent of the rate of temperature change. In FIG. 9a, the amount of hysteresis was 0.93 K and remained constant regardless of the cooling/heating rates.

### DISCUSSION

The present inventors used well-established techniques for cylindrical clamping pressure cells to develop a cryogenic temperature sensor package that can be directly placed inside a pressure cell where the sample under investigation is located, to ensure accurate monitoring of the temperature of the sample sought to be measured.

A commercial Cernox bare chip sensor with pre-bonded gold lead wires was encapsulated in a WC enclosure with an electrical feedthrough, implemented applying the same principles applied in pressure research. As a result, the “Cernox® thermometer enclosure” was shown to withstand external pressures of up to 15 kbar, consistently maintaining the Cernox® thermometer at ambient pressure. The thermometer remained stable even after multiple repeated thermal cycles.

Although the experiments were performed using the Cernox® thermometer model 1050, which has a recommended cryogenic limit of 1.4 K, the same type of “Cernox enclosure” may be applied to the models 1010 or 1030. Although the current setup was tested only down to 3.2 K, there is no reason why this setup should not function down to the lowest operating temperature of the Cernox® thermometer, allowing the useful temperature range to be extended to 0.1 K. Therefore, the full temperature range of the Cernox® thermometer may now be utilized even under applied pressure.

The Cernox® thermometer enclosure may be easily miniaturized by reducing the size of the rectangular substrate to closely match the size of the sensing element, or by rounding or chamfering the edges of the substrate. Because as the inner diameter of the enclosure decreases, the outer diameter and length thereof can also be made smaller. A thin sapphire substrate, which is prone to breaking, was not directly attempted.

The usefulness of the enclosure may be extended to any situation where an isolated space at ambient pressure is required in high-pressure environments. One example could be a resistive bridge circuit designed to detect small changes in resistance under high pressure.

While preferred embodiments of the present disclosure have been described above with reference to the drawings and examples, these embodiments are merely illustrative, and it will be apparent to those skilled in the art that various modifications and equivalent implementations can be made therein. Therefore, the scope of the present disclosure should be defined by the appended claims.

### EXPLANATION OF REFERENCE NUMERALS DESIGNATING THE MAJOR ELEMENTS OF THE DRAWINGS

| | |
|---|---|
| 1: Pressure cell | 10: Thermometer enclosure |
| 11: Plug | 11a: Base portion |
| 11b: Insert portion | 12: Cap |
| 20: Obturator | 21: Base portion |
| 22: Pressurizing portion | 30: Main body |
| 31: Outer body | 32: Inner body |
| 40: Clamping nut | es: Extra space |
| sf1: Surface of base portion | sf2: Surface of cap |
| slt1, slt2: Sealant | lw1, lw2: Lead wire |
| TC: Temperature sensing element | scpf: Sealing capsule fixing portion |
| ch1, ch2, ch3, ch4: Central hole | efd: Electrical feedthrough |
| scp: Sealing capsule | pm: Pressure-transmitting medium |
| att: Attachment | gr: Groove |
| sc1: Female thread | sc2: Male thread |

1. A thermometer enclosure comprising:
a plug; and
a cap disposed to cover the plug,
wherein the plug comprises a base portion and an insert portion that are formed integrally with each other,
wherein the base portion and the insert portion are disposed sequentially in a first direction,
wherein a length of the insert portion in a second direction perpendicular to the first direction is smaller than a corresponding length of the base portion, and
wherein the base portion and the insert portion each comprise a central hole formed therein, the central hole passing through the base portion and the insert portion in the first direction.

2. The thermometer enclosure of claim 1,
wherein the base portion of the plug, the insert portion of the plug, and the cap each have a hollow cylindrical shape.

3. The thermometer enclosure of claim 1,
configured so that while the cap fully covers the plug, there exists an extra space between the insert portion of the plug and the cap.

4. The thermometer enclosure of claim 3,
further comprising a lead wire inserted into the plug via the central hole, wherein one end portion and the other end portion of the lead wire are exposed to the outside of the central hole.

5. The thermometer enclosure of claim 4,
further comprising a temperature sensing element, wherein the temperature sensing element is attached to the lead wire exposed toward the extra space formed between the insert portion of the plug and the cap.

6. The thermometer enclosure of claim 4,
further comprising an electrical feedthrough disposed in the central hole.

7. The thermometer enclosure of claim 1,
wherein the cap is configured so that while the cap fully covers the plug, a surface of the cap opposing the base portion of the plug is flat, and the plug is configured so that a surface of the base portion opposing the cap is tapered, so that a gap between the cap and the base portion gradually widens from the center to an end along the second direction.

8. An obturator comprising a base portion and a pressurizing portion that are formed integrally with each other,
wherein the base portion and the pressurizing portion are disposed sequentially in a first direction,
wherein a length of the pressurizing portion in a second direction perpendicular to the first direction is smaller than the corresponding length of the base portion, and
wherein a tip portion of the pressurizing portion comprises a groove configured to accommodate the thermometer enclosure according to claim 1,
wherein the base portion and the pressurizing portion have a central hole formed therein, the central hole passing through the base portion and the pressurizing portion in the first direction.

9. The obturator of claim 8,
wherein a diameter of the groove is larger than a diameter of the thermometer enclosure, and the central hole is in communication with the groove.

10. The obturator of claim 8,
wherein the base portion and the pressurizing portion each have a hollow cylindrical shape.

11. The obturator of claim 8,
further comprising a sealing capsule fixing portion formed on an outer surface of the tip portion of the pressurizing portion.

12. An obturator-thermometer enclosure assembly, comprising: the obturator of claim 8; and
a thermometer enclosure accommodated in the groove formed on the tip portion of the pressurizing portion of the obturator.

13. The obturator-thermometer enclosure assembly of claim 12,
wherein the lead wire included in the thermometer enclosure extends out of the central hole through the central hole formed in the obturator and a gap between the thermometer enclosure and an inner wall of the pressurizing portion defining the groove.

14. The obturator-thermometer enclosure assembly of claim 13, further comprising
an electrical feedthrough disposed in the central hole and the gap between the thermometer enclosure and the inner wall of the pressurizing portion defining the groove.

15. The obturator-thermometer enclosure assembly of claim 13, further comprising
an attachment attached to the lead wire exposed to the outside of the pressurizing portion of the thermometer enclosure.

16. The obturator-thermometer enclosure assembly of claim 15,
wherein the attachment comprises a sample, a temperature sensor, a pressure sensor, or a combination thereof.

17. A pressure cell comprising the obturator-thermometer enclosure assembly of claim 12.

18. The pressure cell of claim 17, comprising:
an outer body in a hollow cylindrical shape;
an inner body in a hollow cylindrical shape and configured to be insertable into a hollow of the outer body;
the obturator-thermometer enclosure assembly configured to be insertable into a hollow of the inner body; and
a clamping nut configured to be threadedly engaged with the outer body to positionally secure the obturator.

19. The pressure cell of claim 18,
wherein the outer body and the inner body are pre-stressed.

20. The pressure cell of claim 18,
wherein the outer body is formed such that an inner wall thereof is tapered in a length direction, and the inner body is formed such that an outer wall thereof is tapered in a length direction.

21. The pressure cell of claim 20,
wherein an outer diameter of the inner body is configured to be larger than a corresponding inner diameter of the outer body.

22. The pressure cell of claim 18,
configured so that while the obturator-thermometer enclosure assembly is fully inserted into the hollow of the inner body, there exists an extra space between the pressurizing portion and the inner body.

23. The pressure cell of claim 22, further comprising
a pressure-transmitting medium filled in the extra space between the pressurizing portion and the inner body.

24. The pressure cell of claim 18,
further comprising a hollow sealing capsule having an opening, wherein the sealing capsule is disposed such that an entire outer surface of the sealing capsule is in close contact with an inner wall of the inner body, and an inner surface of the sealing capsule around the opening is in close contact with the sealing capsule fixing portion of the obturator.
